(19) United States
(12) Patent Application Publication
(10) Pub. No.: US 2008/0270193 A1
(43) Pub. Date: Oct. 30, 2008

(54) Transfer of risk of repair costs with renewal rights

(75) Inventor: Todd A. Beikmann, Prairie Village, KS (US)

Correspondence Address: Allan W. Watts;Bryan Cave LLP, Suite 2200, 2 N. Central Avenue, Phoenix, AZ, 85004, US

(73) Assignee: BTB LLC, Prairie Village, KS (US)

(21) Appl. No.: 11/796,193

(22) Filed: Apr. 27, 2007

(51) Int. Cl. G06Q 40/00; G01C 22/00; G06Q 90/00

(52) U.S. Cl. 705/4; 116/62.1; 283/54

(57) ABSTRACT

Methods of transferring risk of costs for repairs, methods of providing funding for repair costs, and articles for transferring risk of repair costs. Articles may be service contracts, and the methods and articles may apply to one or more apparatuses, which may be motor vehicles, for instance. The methods and articles may include a right for the purchaser to renew a contract for one or more periods of time, or may include a provision to convert any unearned payment into extended funding for repair services in the event that anticipated payments are not made. A customer may pay for an initial term, after which the customer may renew for second or subsequent periods of time at the customer's option. A motor vehicle service contract may terminate after a delineated number of miles is reached, and an auto-renewal status may be reached after a particular number of payments are made.

### FIELD OF INVENTION

This invention relates to methods and articles for providing funding for repair costs or for transferring risks associated with repair costs. Specific embodiments of this invention relate to service contracts, for example, for vehicles.

### BACKGROUND OF THE INVENTION

As machines have become more complex and more expensive, the costs associated with breakdown, repair, and servicing of machines has become more of a concern to the owners of such machines. Examples of such machines or apparatuses include vehicles, such as automobiles, including passenger cars, trucks, recreational vehicles, and motorcycles, for instance. In certain instances, costs associated with breakdown and repair can exceed the liquid assets available to particular owners. Consequently, in many cases, owners are adverse to the risks associated with unanticipated repairs and desire to reduce or limit such risks. In response, providers, such as insurance companies, have been know to help such owners reduce such risks by taking on risks in exchange for the purchase of a service contract. Providers typically sell service contracts to a number of owners and distribute the risks in a manner such that the payment received from the policy holders generally exceeds the payout in claims, thus resulting in a profit for the providers.

In the specific area of vehicle repair and service contracts for vehicles, warranties or service contracts have been offered upon the sale of a new or used vehicle to reduce the risks to the purchaser of incurring the costs of expensive repairs. Such warranties and service contracts have fulfilled the needs of purchasers to avoid risk while also fulfilling the needs of automobile manufacturers and dealers by encouraging sales. However, warranties and service contracts typically sold with new or used vehicles usually expire after a certain amount of time, number of miles on the vehicle, or both, and many vehicle owners wish to reduce their risks of incurring high repair costs after the original warranty or service contract expires. Responsive to this desire and need, extended warranties and service contracts have been provided for vehicles, for example, that provide coverage after an original warranty has expired due to an exceedance of a threshold of time or miles on the vehicle. Call centers or direct mailers have obtained a list of names and contact information for owners of vehicles who's original warranties or service contracts may be expiring. Advertisements have been sent and calls have been made to these potential customers inquiring whether they have an interest in purchasing a service contract.

When original warranties have been sold with the purchase of a vehicle, for example, a lump sum was typically paid for the warranty which often was financed with the vehicle. In the prior art, this model was repeated for service contracts sold separately from a vehicle purchase. A lump sum payment was typically paid to the insurance provider up front, but this lump sum was typically financed so that the purchaser would not have to come up with the full amount of the cost of the service contract all at once. Prior to this invention, the entire vehicle service contract industry sold coverage for a specific and set period of time as defined in the contract without a contractual right to renew for a contracted amount of money.

However, this method of doing business caused problems for both the purchaser and the seller. First, the purchaser was committed to paying off the entire service contract. This left the purchaser with few options if his financial situation changed after signing up for the service contract, for example. Second, some potential purchasers of service contracts were reluctant to sign up for a service contract because they did not want to make a commitment to make payments for the entire contract. Further, since a lump sum and loan were involved, a potential purchaser had to be informed of the total sum of the payments, which often discouraged sales.

To avoid purchasers being held to pay off such a contract, laws have been enacted to require that a purchaser have a right to be released from a service contract commitment. But certain problems remain regarding how to distribute the loss of anticipated revenue in such an instance between the provider, call center, and finance company, for example. Typically, the call center and provider must pay back at least part of their otherwise-realized income in order to pay off the financing. Call centers were often taxed on funds that were not actually earned.

Further, prior art service contracts were typically paid off in a short time. This provided the advantage to the purchaser that payments would not continue for very long, but had the disadvantage that the payments were relatively high. This system eliminated many potential purchasers who did not have enough disposable income to make the payments in the short term.

Consequently, needs and the potential for benefit exist in the providing of service contracts. For instance, needs and potential for benefit exist to be able to provide service contracts wherein a purchaser can cancel the contract at any time without the need to make further payments. To accomplish this, needs and potential for benefit exist to be able to allow a purchaser to cancel a service contract at any time without the need for a call center or insurance provider to pay back income that has already been realized. Further needs and potential for benefit exist to be able to provide service contracts without incurring the cost of financing a lump sum payment up front. Further still, needs and areas for potential for improvement include providing service contracts that have lower monthly payments so that more people are able to afford service contracts.

In addition, in some past scenarios, payments made for various types of service contracts have been made, or considered to have been made, before the payments were actually completely earned through the provision of coverage. In such scenarios, the recipients of the payments were sometimes considered to be required to return at least a portion of the payments (the unearned portion) to a customer if the customer stopped making payments for a service contract or cancelled he contract. In practice, such a portion of payments were returned to some customers so situated, but not others, resulting in an inequitable situation where some customers were never compensated for an unearned portion of their payments. This inequitable situation has not been addressed in the industry prior to this invention except by providing a refund of unearned payments only to customers who demanded such a refund.

Thus, a need or potential for improvement exists for a coverage provider to legitimately retain unearned portions of payments for service contracts that are cancelled prematurely, and to provide to customers in such situations value commensurate with the unearned payment. Potential for improvement exists in these and other areas that may be apparent to a person of skill in the art having studied this document.

### SUMMARY OF PARTICULAR EMBODIMENTS OF THE INVENTION

This invention provides, among other things, methods of transferring risk of costs for repairs, methods of providing funding for repair costs, and articles for transferring risk of repair costs. These articles may be contracts, such as service contracts, for example, and the methods and articles may apply to one or more apparatuses, which may be vehicles, such as motor vehicles, for instance. The methods and articles may include a right for the purchaser to renew a contract for one or more periods of time, or may include a provision to convert any unearned payment into extended funding for repair services in the event that anticipated payments are not made.

Various embodiments of the invention provide as an object or benefit that they partially or fully address one or more of the needs, potential areas for improvement, and functions described herein, for instance. The present invention provides various embodiments that may provide service contracts wherein a purchaser can stop making payments, for example, at any time, and allow the service contract to expire. To accomplish this, a purchaser may be permitted to stop making payments at any time without the need for a call center or insurance provider to pay back income that has already been realized. Certain embodiments provide service contracts without incurring the cost of financing a lump sum payment up front. And some embodiments provide service contracts that have lower payments so that more people are able to afford them.

Other embodiments provide as an object or benefit methods, contracts, or articles whereby a coverage provider may legitimately retain unearned portions of payments for service contracts that are cancelled prematurely, and provide to customers in such situations value commensurate with the unearned payment in the form of extended coverage. Further features and advantages of the invention may be apparent to those skilled in the art.

A number of specific embodiments of the invention provide various methods of transferring risk of repair costs for repairs to an apparatus. These particular methods include at least providing a written document to be signed by an owner of the apparatus to form a contract wherein the contract provides for funding for repairs to the apparatus for a first period of time in exchange for a first payment. In addition, the contract provides the owner a right to renew the contract for at least a plurality of second periods of time subsequent to the first period of time upon submission of a second payment for each second period of time. The amount of the second payment may be delineated in the contract in these embodiments.

Further, in some embodiments the first period of time and the second period of time are each no less than one week and no more than one quarter (or one half) of one year, for example. And more-specifically, in some embodiments the second periods of time are each one month. Furthermore, in particular embodiments, the funding for repairs is provided in accordance with a set of terms which may be substantially the same for the first period and at least one second period. Moreover, in some embodiments the apparatus is a vehicle having an odometer and the terms change when the odometer reaches a distance reading delineated in the contract. Specifically, in some embodiments the contract terminates when the odometer reaches a particular reading. In addition, in various embodiments, the contract delineates a particular number of second payments after which the contract reaches an auto-renewal status during which the funding for repairs continues without further second payments, for example, until the odometer reaches the distance reading delineated in the contract.

A number of embodiments of these methods also include one or more additional operations, such as entering into the contract with the owner to provide the funding for repairs. Further, some embodiments include offering to a purchaser at the time of the purchase of the apparatus, the transferring of risk of repair costs for repairs to the apparatus; discussing the funding for repairs to the apparatus with the purchaser; and providing the written document to the purchaser.

Further, some alternative embodiments also include advertising to potential customers regarding the transferring of risk of repair costs for repairs to the apparatus; receiving telephone calls from at least a portion of the potential customers in response to the advertising; discussing the funding for repairs to the apparatus with the portion of the potential customers on the telephone; and sending a written document to at least a portion of the potential customers. In some of these embodiments, at least a fraction of the potential customers are the owners of the apparatus, for example, which may be a vehicle. And in some such embodiments, advertising to potential customers includes targeting purchasers of vehicles, purchasers of service contracts, or both.

Further, various embodiments of the invention include methods of providing funding of repair services for an apparatus. These particular methods include at least providing a written document to be signed by an owner of the apparatus to form a contract wherein the contract provides funding for repair services for the apparatus for at least a period of time in exchange for at least a plurality of payments, and wherein the contract provides for any unearned portion of the payments to be converted to extended funding for repair services for the apparatus when and if the owner stops making payments before completion of an anticipated payment schedule. Various specific embodiments of these methods include other operations and aspects of the methods described above.

Other specific embodiments of the invention include an article for transferring risk of repair costs for repairs to a motor vehicle. Risks may be transferred, for example, from the owner to a provider. Such an article may comprise a written document to be signed by an owner of the motor vehicle to form a contract to provide funding for repair services for the motor vehicle for a first period of time in exchange for a first payment. In addition, in such embodiments the contract provides the owner a right to renew the contract for funding for repair services for a second period of time immediately subsequent to the first period of time upon submission of a second payment delineated in the contract. Furthermore, in such embodiments the contract provides the owner a right to repeatedly renew the contract for funding for repair services for a plurality of subsequent periods of time subsequent to the second period of time upon submission of subsequent payments delineated in the contract for each subsequent period of time.

Similar to the methods described above, in specific embodiments of articles, at least a plurality of the subsequent periods of time are each one month, for example. Further, in some embodiments, the motor vehicle has an odometer and the contract terminates when the odometer reaches a distance reading delineated in the contract. Further still, in some of these embodiments, the contract delineates a particular number of payments after which the contract reaches an auto-renewal status during which the funding for repair services continues without further subsequent payment until the odometer reaches the distance reading delineated in the contract.

### BRIEF DESCRIPTION OF THE DRAWINGS

FIG. 1 is a block diagram illustrating various entities that may be involved in transferring risks of repair costs and providing funding for repair services; and

FIG. 2 is a flowchart illustrating a method for transferring risks of repair costs and providing funding for repair services.

### DETAILED DESCRIPTION OF EXAMPLES OF EMBODIMENTS

Various embodiments of this invention concern the transfer of risk associated with costs of repairing one or more apparatuses. An example of such an apparatus is a vehicle, such as a motor vehicle, and certain embodiments apply just to motor vehicles, while other embodiments apply to other apparatuses or to apparatuses in general. Embodiments for vehicles or motor vehicles are described herein in some cases as examples of the invention. The invention allows the owner of an apparatus to transfer risk of repair costs in exchange for payment while allowing the owner flexibility in future decisions and, in many embodiments, reducing periodic payments required. Certain embodiments of this invention allow the vehicle service contract industry to sell service contract coverage for a flexible period of time as defined in the contract giving the purchaser a contractual right to renew for a contracted amount of money. In other words, certain embodiments of the invention allow a customer owner to purchase vehicle coverage on a “pay-as-you-go basis. Further, particular embodiments of this invention make a pay-as-you-go contact actuarially sound and acceptable to the regulations set by States as to vehicle service contracts.

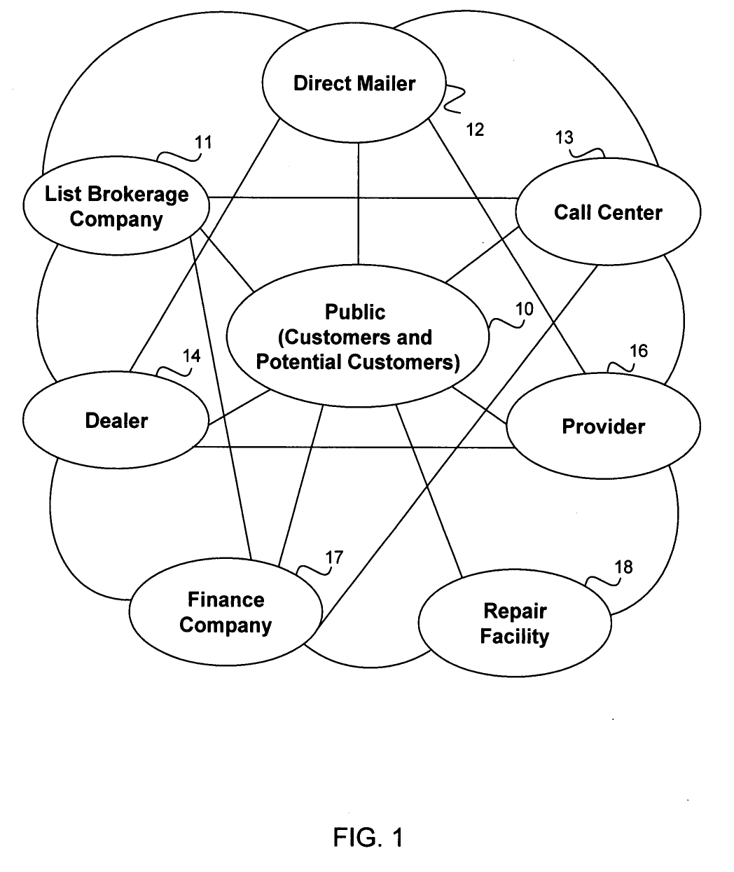

Turning now to the figures, FIG. 1 is a block diagram illustrating various players that may be present in the universe of certain embodiments of the invention. Certain examples will be described wherein the apparatus is a motor vehicle, but it should be noted that various embodiments of the invention may apply to other apparatuses such as home appliances, homes, industrial equipment, commercial or industrial buildings, HVAC equipment, Segways, aircraft, spacecraft, satellites, boats, ships, rail equipment, farming equipment, construction equipment, mining equipment, military equipment, power generation equipment, computer equipment, Internet servers, communications equipment, refrigerators, cooking equipment, pool filters and equipment, and entertainment equipment such as televisions, as examples. Some of these examples are motor vehicles, and other examples of motor vehicles include cars, light to heavy trucks, motorcycles, recreational vehicles, motor homes, quads, snow mobiles, hover craft, military transport vehicles, and dune buggies. Other examples of vehicles include trailers and bicycles.

At the center of FIG. 1, and the center of the invention, is the public 10, which may include customers, potential customers, or both, and may include others as well. Members of the public 10 may include purchasers or owners of apparatuses or vehicles, or others who may have responsibilities or concerns regarding the apparatuses or vehicles, for example. In certain embodiments, one or more list brokerage companies 11 may compile information on the public 10, which may include compiling names, phone numbers, mailing addresses, e-mail addresses, fax numbers, information on apparatuses or vehicles owned, warranty or service contract information, credit information, or the like, or a combination thereof. The information that list brokerage company 11 compiles may identify potential customers from within public 10, for example, indicating individuals who own apparatuses or vehicles, individuals who have warranties or service contracts, and in some cases, when those warranties or service contracts expire, etc. List brokerage company 11 may obtain information directly from the public 10, or from other sources, such as from apparatus or vehicle dealers 14, finance companies 17, or the like.

Still referring to FIG. 1, one or more direct mailers 12 may be in the business of mailing information, offers, advertisements, and the like to the public 10, often to select potential customers within the public 10, which may be identified via information provided by list brokerage company 11. Similarly, one or more call centers 13 may be in the business of placing phone calls to, or receiving phone calls from, the public 10, often to (or from) select potential customers within the public 10, which may be identified via information provided by list brokerage company 11. In some embodiments, direct mailer 12 and call center 13 may be the same entity, or part of another entity, although not always.

In some embodiments, direct mailer 12 may send advertisements to select members of the public 10, and these advertisements may ask the members of the public 10 to call the call center 13 if they are interested in the products or services advertised. In some embodiments, direct mailer 12 may send a contract document or an offer to potential customers (of public 10), which the potential customers may sign and send back (or to another entity) to form a contract and become customers (a subset within public 10).

It should be understood that direct mailer 12 may use regular mail, private delivery services, e-mail, text messaging, facsimile, or the like. Call Center 13 may use traditional telephone networks, wireless telephone networks, voice-over-Internet protocol, etc., or a combination thereof. Direct mailers 12, call centers 13, or both may perform services manually (e.g., using real people) or may be automated, in whole or in part, for example, using recorded messages, machine-read forms, websites configured to input data, etc.

As an alternative, or in addition, members of the public 10, which may include potential customers, customers, or both, may be contacted in person, for example, when they are at dealers 14. People may be approached at dealer 14 by a sales person, for example, after agreeing to purchase a vehicle or other apparatus, when having service done, etc., which will be described in more detail below.

In many embodiments, a provider 16 may provide coverage to customers from within the public 10. Such coverage may be provided in the form of policies, service contracts, warranties, extended warranties, or the like. Provider 16 may include one or more administrators, agents, brokers, claims adjusters, and the like. Customers may be directed to provider 16 via direct mailer 12, call center 13, dealer, 14, or a combination thereof, for example. Provider 16 may receive and process claims, pay claims, etc., interacting with customers from within public 10. Certain embodiments of the invention also include finance company 17, which may provide financing through dealer 14 for the purchases of apparatuses or vehicles by members of the public 10, (purchasers) for instance. In some embodiments, finance company 17 may provide financing for some or all policies or service contracts sold or issued by provider 16 to members of the public 10. Actual repairs to the apparatus or vehicle may be made by dealer 14 or by repair facility 18, for example, which may be paid by provider 16 directly, or by customers (within public 10), who then may be reimbursed by provider 16 in some embodiments.

Not shown in FIG. 1 are one or more underwriters who may provide funding to provider 16 if provider 16 lacks adequate funding to pay all of the legitimate claims made by customers (from within public 10). Other players not show are various levels of government, including states, which may provide regulations for service contracts, list brokerage company 11, direct mailer 12, call center 13, dealer 14, provider 16, finance company 17, and repair facility 18, among other things. Also worth noting, members of the public 10 who are not customers, purchasers, or even owners, in some cases, may depend upon or benefit from an apparatus or vehicle who may suffer if an apparatus or vehicle fails to function due to a need for repairs, and benefit from repairs made by repair facility 18 to the apparatus or vehicle which are funded by provider 16.

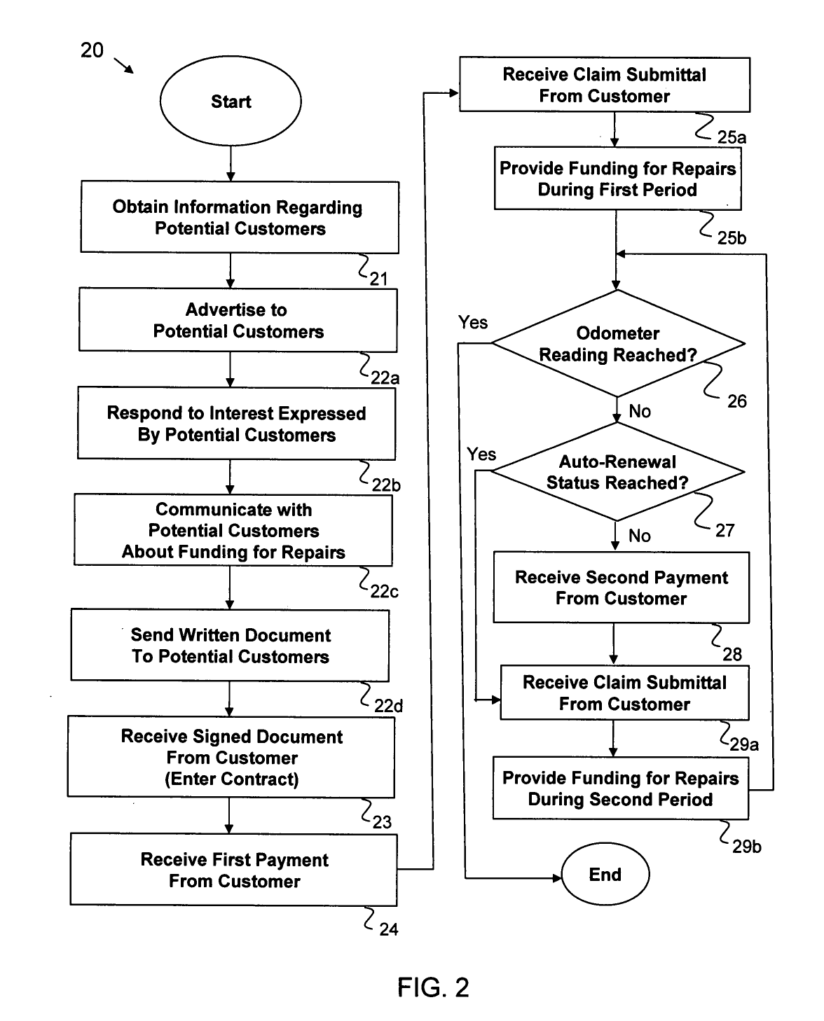

Turning now from players to methods in accordance with the invention, a number of specific embodiments of the invention provide various methods of transferring risk of repair costs for repairs to an apparatus. FIG. 2 illustrates an example of a method 20 in accordance with the invention. Various embodiments of the invention may include various numbers of steps or operations shown in FIG. 2. Looking now at those operations, method 20 includes operation 21 of obtaining information regarding potential customers. Information may be obtained from list brokerage company 11, shown in FIG. 1, for example. In some embodiments, at least a fraction of the potential customers are the owners of the apparatus, for example, which may be a vehicle, for instance. In various embodiments, information may be obtained about the owners of apparatuses or vehicles, for example, or others who are responsible for repair of apparatuses or vehicles. In some embodiments, information may be obtained on individuals who already have or manage warranties, service contracts, or policies, for instance, which are about to expire, have recently expired, or are likely to have recently expired or be about to expire. Expiration may result from the passage of time, or in the case of a vehicle, for example, by exceeding an odometer reading or threshold.

In the embodiment illustrated, method 20 also includes operation 22a of advertising to potential customers. Such advertising may include sending written advertising material in the mail, sending e-mails, sending facsimiles, handing out flyers, sending text messages, calling on a telephone, leaving voice mail messages, advertising on one or more Internet websites, advertising in periodical publications, advertising on bill boards, advertising on television or radio, etc., and may be performed by direct mailer 12 or call center 13 shown in FIG. 1, for example. In some embodiments, advertising (e.g., of operation 22a) may be provided at or by dealer 14, provider 16, repair facility 18, direct mailer 12, call center 13, provider 16, agents, brokers, or a combination thereof.

In some embodiments, the operation 22a of advertising to potential customers includes targeting purchasers of vehicles, purchasers of service contracts, or both. In particular embodiments, the advertising may specifically target individuals who's warranty or service contract has recently expired or is about to expire (or is likely to). The advertising material may inform the recipient regarding the status of their existing warranty or service contract, advise regarding potential costs of repairs, advise regarding service contracts, or a combination thereof, as examples. In some embodiments, the advertising (operation 22a) may include informing or advertising to potential customers regarding transferring of risk of repair costs for repairs to an apparatus or, for example, a vehicle.

In some embodiments, interested recipients of the advertising (operation 22a) may be asked to respond, for example, by calling a telephone number, visiting a website, clicking on a link, sending an e-mail, sending a facsimile, or the like, and may be given several options to choose from for responding in some embodiments. In particular embodiments, potential customers may be advertised to (operation 22a) by direct mail from direct mailer 12 and may be asked to respond by telephone by calling call center 13, for example.

In various embodiments, once a potential customer (e.g., from the public 10) expresses interest in a service contract, for example, the next operation may be to respond to the interest expressed by the potential customer or customers (operation 22b). Some methods in accordance with the invention include receiving telephone calls from at least a portion of the potential customers (e.g., from the public 10) in response to the advertising (operation 22a). Some embodiments also include communicating about funding of repairs, such as discussing the funding for repairs to the apparatus with at least a portion of the potential customers on the telephone, for example (operation 22c). For example, potential customers may be informed of the potential magnitude and risks of repair costs and the option to enter into a service contract to transfer the risk of such costs to someone else in exchange for a manageable payment. In some embodiments, risks of repair costs and the option to enter into a service contract may be provided, in addition (or instead), in previous or original advertisements (e.g., operation 22a).

Further, some embodiments of the invention include sending a written document to at least a portion of the potential customers (operation 22d). Such a written document may be a contract document or an offer, for example, which may form a contract once signed by the customer and returned to the provider 16, for example. In some embodiments, the written document may be a service contract, for instance, for a motor vehicle. The written document may be sent by mail, e-mail, posting on an Internet website, or facsimile, for example.

Thus, method 20, in this embodiment, includes operation 23 of receiving the signed document (e.g., sent unsigned to the potential customer in operation 22d) from the customer. In some embodiments, the customer may mail, e-mail, or fax the signed document to the provider 16, for example, or may indicate acceptance of the document on an Internet website, mobile wireless device, or the like. Receipt of the signed document may form a contract, or in some embodiments, the signed document (e.g., received in operation 23) may be considered to be an offer and the provider 16 may reserve the right to accept or reject the offer. For example, the offer or document received in operation 23 may be accepted to form a contract or rejected based on an investigation of the customer, an inspection of the apparatus, receipt of payment, or the like, or a combination thereof. In such cases, the formation of a contract may be consummated by provider 16 notifying the customer (a member of public 10), for example, by mail, e-mail, text message, or fax. Thus, various embodiments, include entering into a contract with a customer (e.g., the owner of the apparatus or vehicle) to provide funding for repairs (e.g., to the apparatus or vehicle).

In particular embodiments, method 20 also includes operation 24 of receiving a first payment from the customer. In various embodiments, payment may be provided (operation 24) to provide coverage (e.g., by provider 16) or a service contract for an apparatus, which may be a vehicle, for example. In some embodiments, payment may be received (operation 24) with the signed document (e.g., received in operation 23). In some embodiments, receipt of payment (operation 24) may form a contract, or at least a contract may be deemed to have been formed if the payment is received and not returned promptly or within a reasonable time to the customer. Coverage may be provided (at least initially) for a first period of time, which may be a week, more than a week, 15 days, 30 days, a month, more than a month, 45 days, 60 days, two months, 90 days, three months, less than a quarter of a year, a quarter of a year, four months, six months, half of a year, less than a half of a year, a year, or two years, as examples. Further, in some embodiments the first period of time is no less than one week and no more than one quarter of one year, for example. Further still, in some embodiments, the first period of time is no less than one week and no more than one half of one year, as another example. In particular embodiments, the first time period is 60 days, for instance.

Embodiments are also anticipated wherein opportunities to transfer risk or provide funding for repair services are offered to customers at the time of the purchase of a new or used apparatus. For example, the seller of the apparatus (e.g., dealer 14) may offer customers a service contract after the customer has agreed to purchase the apparatus. In some embodiments, the service contract may be paid for outside of the financing for the apparatus or vehicle, for example. Thus, some embodiments include offering to a purchaser at the time of the purchase of the apparatus, the transferring of risk of repair costs for repairs to the apparatus. This may be similar to operation 22a, except may be done in person by a sales person, with or without the use of printed advertising materials. In some embodiments, such a method may include discussing the funding for repairs to the apparatus with the purchaser, which may be similar to operation 22c, but also probably in person in most cases. Further, many embodiments include providing the written document to the purchaser, which may be similar to operation 22d, except that the document may be given to the purchaser by hand rather than by mail, e-mail, fax, etc. In many other respects, such a method may be similar to method 20 shown in FIG. 2.

During the first period of time, after a contract has been entered into (operation 23 in some embodiments) and a first payment has been received (operation 24), for example, a customer may be entitled to submit claims for covered repairs to the apparatus or vehicle. Thus, if a covered repair is necessary during the first period, a claim submittal may be received (operation 25a) from the customer. In some cases, more than one claim submittal may be received (operation 25a) from a customer, for example, if multiple covered repairs happen to be required. In some embodiments, repairs may need to be approved in advance, and in some embodiments, only certain types of repairs may be covered. In various embodiments, different policies may be available with different levels of coverage, for example, covering different parts or types or repairs, having different deductibles, requiring different payments (e.g., received in operation 24) etc.

In some embodiments, claims may be submitted (operation 25a) to provider 16, for instance, to a claim department or claims adjustor. In such embodiments, provider 16 may process the claim, and if covered, provide funding for repairs made during the first period (operation 25b). In certain embodiments, payment may be made directly to a repair facility 18 or dealer 14 by provider 16, for example. In other cases, the customer (10) may pay for the repairs and then seek reimbursement from the provider 16, or the provider 16 may pay the customer who then pays the repair facility 18 or dealer 14.

Various of these particular methods 20 described include at least providing a written document (e.g., operation 22d) to be signed by an owner of an apparatus to form a contract (e.g., in operation 23) wherein the contract provides for funding (e.g., operation 25b) for repairs to the apparatus for a first period of time in exchange for a first payment (e.g., received in operation 24). In addition, as will be described next, in various embodiments the contract provides the owner a right to renew the contract for at least a plurality of second periods of time subsequent to the first period of time upon submission of a second payment for each second period of time. Such second payments may be received from the customer, in the example of method 20, in operation 28, for instance. The amount of the second payment (e.g., received in operation 28) may be delineated in the contract in some such embodiments.

In particular embodiments, a customer may renew the contract for a second time period merely by providing the second payment (e.g., received in operation 28) for that period. Payments described herein (e.g., received in operations 24, 28, or both) may be made, for example, by sending a check, electronically, by authorizing payment from a credit card or debit card, in cash, or the like. In some embodiments, automatic payments may be authorized and the customer or owner may cancel the contract or policy by withdrawing the authorization for automatic payments, or the contract or policy may terminate automatically if funds for payment are not available. In some embodiments, the contract may provide substantially the same or the same coverage for the second or subsequent time periods as for the first time period.

If a second payment has been made for a period (e.g., received in operation 28), then the customer may be entitled to submit claims for covered repairs to the apparatus (e.g., received in operation 29a). Such claims may be processed by provider 16, and if found to be covered, funding for repairs may be provided (operation 29b), for example, from provider 16 to customer (10). In some embodiments, a customer may have a right to renew the contract for a plurality of second time periods. Further, in various embodiments, the number of potential second time periods may be limited to a certain number or may be indefinite.

The written document sent in operation 22d and received in operation 23 may be, in many embodiments, an article for transferring risk of repair costs for repairs to an apparatus such as a motor vehicle. Risks may be transferred, for example, from the owner (within public 10) to provider 16. Such an article may be written to form a contract to provide funding for repair services (e.g., operation 25b) for the motor vehicle for a first period of time in exchange for a first payment (e.g., received in operation 24). In addition, in some embodiments the contract provides the owner a right to renew the contract for funding for repair services (e.g., operation 29b) for a second period of time immediately subsequent to the first period of time upon submission of a second payment (e.g., received in operation 28) delineated in the contract. Furthermore, in various embodiments, as illustrated by method 20, the contract provides the owner a right to repeatedly renew the contract for funding for repair services (e.g., operation 29b) for a plurality of subsequent periods of time subsequent to the second period of time upon submission of subsequent payments delineated in the contract for each subsequent period of time. In different embodiments these subsequent periods of time may be equal to the second periods of time and the subsequent payments may be equal to the second payments, or the subsequent and second periods and payments may differ. The subsequent periods may be within the ranges or of one or more of the durations described herein for the second or first periods of time, for example.

In various embodiments, direct mailer 12, call center 13, dealer 14, provider 16, or a combination thereof, may realize (for tax or accounting purposes, for example) payments received in operations 24, 28, or a combination thereof, when the payments are received or at the start or end of the period for which a payment is to provide coverage. In many embodiments, direct mailer 12, call center 13, dealer 14, provider 16, or a combination thereof will not be obligated to return any payments (e.g., received in operations 24 or 28) to a customer, even if the customer cancels the policy, either upon receipt of the payment, start of the period, or end of the period that a payment is for. In various embodiments, a customer can cancel a policy or service contract by not making the next second or subsequent payment (e.g., received in operation 28), after which the policy or service contract will automatically expire.

In some embodiments, at least a portion of a policy may be financed, for example, with premium financing. In some embodiments, only payments to an administrator are financed, for example. Financing may be provided, for example, by finance company 17 shown in FIG. 1. In some embodiments, money to call center 13, direct mailer 12, or both, may be fully earned, so they do not ever have to pay it back.

Still referring to FIG. 2, at least for some embodiments in which the covered apparatus is a vehicle having an odometer, one or more of the terms of the article or contract (e.g., service contract) may change when the odometer reaches a distance reading delineated in the contract. Specifically, in some embodiments the contract terminates when the odometer reaches a distance reading delineated in the contract. Such a distance reading may be 50,000, 60,000, 70,000, 75,000, 80,000, 90,000, 100,000, 110,000, 120,000, 125,000, 130,000, 140,000, 150,000, 160,000, 175,000, 200,000, 250,000, 300,000, or 500,000 miles, for example, or a number within a range defined by one or more of these numbers, or a metric system equivalent. Such a distance reading may be 100,000 miles, for passenger cars, for example. In the example illustrated, method 20, decision operation 26 evaluates whether an odometer reading has been reached (or exceeded). In various embodiments, the customer or owner, repair facility 18, provider 16, or dealer 14, or a combination thereof may be responsible for determining when the odometer reading has been reached or exceeded.

In the example shown in FIG. 2, if the odometer reading has been reached, (in operation 26), then the contract terminates. For example, the provider 16 may no longer be required to provide funding for repairs (e.g., in operation 25b), in some embodiments, even if a period of time, for example, the first period of time, has not been exceeded. Consequently, in such embodiments, the customer or policy holder may have no reason to make any more payments (e.g., second payments, to be received in operation 28). Further, in embodiments that terminate based on mileage, coverage may extend indefinitely in terms of time, for example, if the vehicle is not driven at all or very much. In other embodiments, coverage may terminate after a particular amount of time, even if the applicable odometer reading has not been reached.

In some embodiments, (e.g., illustrated by the logic of the flow chart of method 20) funding for repairs during the first period may be independent of mileage or odometer reading, while coverage under the second time periods or the right to renew may terminate when a particular odometer reading has been reached. Further, in certain embodiments, other terms of the contract (e.g., service contract) may change when the odometer reaches a distance reading delineated in the contract. For example, payments (e.g., to be received in operation 28) may change, coverage may change, etc. In some embodiments, terms of the contract may change at several different odometer distance readings, such as some or all of those different odometer readings listed herein. In some embodiments, the contract does not terminate at a particular odometer reading, but rather terminates after a particular amount of miles have been drive since the service contract began, terminates after a particular amount of time, terminates after a particular amount of funding has been provided for repairs (e.g., in operation 25b, 29b, or both), or the like, as examples, or a combination thereof represented by a formula, for instance.

In various embodiments, the second time period may have the same length as the first time period, or may be different (e.g., shorter). In some embodiments, all of the second or subsequent periods have the same duration, although that is not a necessity for all embodiments. The duration of a second period may be one of the examples or within one of the ranges provided above for the first period, for instance. In some embodiments, the second period of time is no less than a week and no more than a quarter of one year, for example. In some embodiments, the duration of a second period (or at least a plurality of the second periods of time) may be one month, which may be measured from a day in one month to the same number day in the next month, even though that duration will change with the length of the month. In some embodiments, a month may be extended to the next business day if day of the month that marks the end of the month falls on a weekend or holiday, for instance. In other embodiments, the duration of the second periods may be 30 days, two months, 60 days, three months, no more than one half of one year, etc.

Furthermore, in particular embodiments, the funding for repairs is provided (e.g., operations 25b, 29b, or both) in accordance with a set of terms which may be substantially the same for the first period and at least one second period. In some embodiments, these terms may remain the same for all of the second periods or for subsequent periods. Such terms may include, for example, the process to qualify for funding and submit claims, the types of repairs that are covered, etc. In some embodiments, the payments (e.g., received in operations 24, 28, or both) may be the same, the same per the length of the period of coverage, the same for all of the second time periods, the same for subsequent periods, or the like.

In addition, in various embodiments, the contract delineates a particular number of second payments (or subsequent payments) after which the contract reaches an auto-renewal status during which the funding for repairs (e.g., operation 29b) continues without further second (or subsequent) payments (e.g., operation 28), for example, until the odometer reaches the distance reading (operation 26) delineated in the contract. In the embodiment illustrated, decision operation 27 evaluates whether the auto-renewal status has been reached. In various embodiments, the auto renewal status may be reached after 6, 9, 12, 18, 24, 30, 36, 42, 48, 54, or 60 second payments (e.g., operation 28) or months, for example. In particular embodiments, the auto renewal status is reached after 36 second payments (e.g., operation 28) or 36 months, for example, which results in a substantially lower monthly payment than what was required for prior art service contracts, allowing many more potential customers to afford such a service contract. Even so, call center 13 may be fully paid in 36 months (in this example) rather than 60 months in a typical prior art method. In addition, in some embodiments, since the customer is not committing to make all 36 payments, it may not be necessary to give the customer the total of the 36 payments.

Further, various embodiments of the invention include methods of providing funding (e.g., operation 25b, 29b, or both) of repair services for an apparatus, which are described with reference to FIG. 2. These particular methods include at least providing a written document (e.g., operation 22d) to be signed by an owner of the apparatus to form a contract (e.g., received in operation 23) wherein the contract provides funding for repair services (e.g., in operation 25b, 29b, or both) for the apparatus for at least a period of time (e.g., a first period, one or more second periods, or a combination thereof in exchange for at least a plurality of payments (e.g., a first payment received in operation 24, one or more second payments received in operation 28, etc., or a combination thereof and wherein the contract provides for any unearned portion of the payments to be converted to extended funding (e.g., provided in operation 29b) for repair services for the apparatus when and if the owner stops making payments before completion of an anticipated payment schedule.

In certain such embodiments, the policy may be paid up front with financing. Such a contract may provide for any unearned portion of payments made to be converted to a monthly renewable contract or to month-to-month coverage from that point forward until all of the unearned payments have been earned through the provision of coverage, for example. Such month-to-month coverage (or other time period) may be similar in various respects to the coverage described herein, for example. Various specific embodiments of these methods include other operations and aspects of the methods described above, for example, method 20.

Other specific embodiments of the invention include articles for transferring risk of repair costs for repairs to an apparatus. This apparatus may be a motor vehicle in some embodiments, for example. Risks may be transferred, for example, from the owner (e.g., a member of the public 10 shown in FIG. 1) to a provider (e.g., 16). Such an article may comprise a written document to be signed by an owner of the motor vehicle, for example, to form a contract to provide funding for repair services for the motor vehicle for a first period of time in exchange for a first payment. In addition, in some such embodiments the contract provides the owner a right to renew the contract for funding for repair services for a second period of time immediately subsequent to the first period of time upon submission of a second payment. This second payment may be delineated in the contract in some embodiments. Furthermore, in such embodiments the contract may provide the owner a right to repeatedly renew the contract for funding for repair services for a plurality of subsequent periods of time subsequent to the second period of time upon submission of subsequent payments delineated in the contract for each subsequent period of time.

Such articles may take the form of policies, service contracts, or the like, and may contain clauses reflecting one or more of the method operations described herein. Further, the articles described herein are examples of a contract, service contract, or policy, referred to in the descriptions of methods herein, which descriptions may refer to FIG. 1 and FIG. 2, for example.

Similar to the methods described above, in specific embodiments of articles, at least a plurality of the subsequent periods of time are each one month, for example. Further, in some embodiments covering a motor vehicle, the motor vehicle has an odometer and the contract changes or terminates when the odometer reaches a distance reading delineated in the contract. In addition in some embodiments, the contract delineates a particular number of payments after which the contract reaches an auto-renewal status during which the funding for repair services continues without further subsequent payment until the odometer reaches the distance reading delineated in the contract.

Articles, such as service contracts, may require prior authorization before repairs begin, may provide payment for towing, may provide payment for a rental car while repairs are being made, may reimburse for motel and restaurant expenses if repairs are required on the road, or a combination thereof. Various embodiments may have deductibles, may identify or describe parts or systems that are covered, and may identify or describe other parts and systems that are specifically not covered. Further, certain embodiments may include clauses for specific states or nationalities to comply with laws in those states or nationalities, or for other jurisdictions.

### EXAMPLE 1

The following is a particular example of the text of an article or written document to be signed by an owner of a motor vehicle to form a contract to provide funding for repair services for the motor vehicle for a first period of time in exchange for a first payment (not specifically shown). In addition, in this example, the contract provides the owner a right to renew the contract for funding for repair services for a second period of time immediately subsequent to the first period of time upon submission of a second payment which would be delineated in the contract. Furthermore, in this example, the contract provides the owner a right to repeatedly renew the contract for funding for repair services for a plurality of subsequent periods of time subsequent to the second period of time upon submission of subsequent payments delineated in the contract for each subsequent period of time.

The following text also further illustrates an example of a method of transferring risk of repair costs for repairs to an apparatus, which in this example is a motor vehicle, wherein the contract provides for funding for repairs to the apparatus for a first period of time in exchange for a first payment and provides the owner a right to renew the contract for at least a plurality of second periods of time subsequent to the first period of time upon submission of a second payment for each second period of time. The following text is subject to copyright protection for the benefit of Todd Beikmann, BTB LLC, or both, 2006. All rights are reserved.

IMPORTANT INFORMATION YOU NEED TO KNOW

CUSTOMER SUPPORT NUMBER—Please see the box labeled Your Contract Number on the Registration Page. This is Your CUSTOMER SUPPORT NUMBER. Please refer to this number in any written or verbal communication, such as requesting information or filing a claim. PURCHASE OF THIS VEHICLE SERVICE CONTRACT IS NOT REQUIRED IN ORDER TO PURCHASE OR FINANCE A MOTOR VEHICLE.

THINGS TO DO NOW

Verify Registration Page—The Registration Page must be attached to the front of this Contract to complete and validate this Contract.

Check Plan Code—Not every part of Your Vehicle is covered by this Contract. Coverage is identified by the last three (3) letters of the Plan Code as shown on the Registration Page of this Contract. Please compare the last 3 letters of the Plan Code on the Registration Page with the Plan Code and Corresponding Coverage as listed under the Schedule of Coverages. If this box was left blank, or the Plan Code is inaccurate, contact Your Administrator immediately.

Check Your Deductible—Please check the box labeled DEDUCTIBLE on Your Registration Page. A dollar amount should be in the box which identifies the portion of the covered repair You will be required to pay if You have a claim. If no dollar amount is in the box, contact Your Administrator immediately.

THINGS YOU MUST DO THROUGHOUT THE TERM OF YOUR CONTRACT

Properly Maintain Your Vehicle and KEEP THE RECEIPTS—This Contract is only valid if Your Vehicle has been maintained in accordance with the manufacturer's specifications. Keep copies of all receipts (oil changes, lubrication, etc.), as proof of maintenance will be required when You file a claim. SEE SECTION: “PROVISIONS OF THIS VEHICLE SERVICE CONTRACT” FOR SPECIFIC MAINTENANCE REQUIREMENTS.

OBTAIN APPROVAL PRIOR TO HAVING WORK PERFORMED THAT MAY BE COVERED BY THIS CONTRACT. If You believe the failure may be covered by this Contract, call the Administrator personally, or instruct the repair facility performing the work to call and Register the claim BEFORE THE WORK IS PERFORMED. SEE SECTION: “CONTRACT HOLDER'S GUIDE TO FILING A CLAIM”.

DEFINITIONS

The following definitions apply to words frequently used in this Contract and appear in Bold Faced Type:

You, Your—Means the Contract Holder shown on the Registration Page

We, Us, Our—Means the obligor of this Contract as stated on the Registration Page attached to this Contract.

Administrator—Means the Administrator as shown on the Registration Page.

Contract—Means this Vehicle Service Contract which You have purchased from Us to protect Your Vehicle.

Registration Page—Means the numbered document which must be attached to and forms part of this Contract. It lists information regarding You, Your Vehicle, Coverage selected, and other vital information.

Schedule of Coverages—Lists the Coverages provided to You for Your Vehicle under this Contract.

Coverage—Means the protection You have selected, as listed in the Schedule of Coverages Section.

Vehicle—Means the Vehicle which is described on the Registration Page.

Deductible—Means the amount You are required to pay, as shown on the Registration Page, for covered Breakdowns. Once a part is repaired or replaced under the terms of this Contract, there will be no Deductible for future repairs to that part.

Breakdown—Means the failure of a covered part under normal service. A covered part has failed when it can no longer perform the function for which it was designed solely because of its condition and not because of the action or inaction of any non-covered parts. Subsequent Damages resulting from the Breakdown of a covered part are covered by this Contract, except when You have failed to perform the recommended maintenance services for Your Vehicle.

Subsequent Damage—Means the direct or immediate damage to a non-covered part occurring as a singular event or failure originating with the failure of a covered part.

Contract Origination Date—means the date the Contract Term begins as stated on the Registration Page.

Contract Term—means the period of time that extends forward 60 days from the Contract Origination Date

Renewal Payment Due Date—means the day of the month that a Renewal Payment is due in order for this Contract to renew till the same date the following month at which time another Renewal Payment will be due. This Contract's Renewal Payment Due Date for each month is listed on the Registration Page of this Contract.

Renewal Term—means the period of time between a Renewal Payment Due Date in which a full Renewal Payment was received, or waived because contract qualifies for Auto Renewal Status, and the same date the following month which a Renewal Payment will be due.

Renewal Payment—means the amount of money due on each Renewal Payment Due Date that must be received by the Administrator for this Contract to renew and provide coverage till the next Renewal Payment Due Date. The Renewal Payment amount is listed on the Registration Page of this Contract.

Auto Renew Status—means the Renewal Payment will be waived at each Renewal Payment Due Date once You have made the maximum number of Renewal Payments listed on the Registration Page. Your Vehicle must have less than 100,000 miles on the odometer and Administrator must have received, in full, all of the Renewal Payments, for the Contract to be placed and remain in Auto Renewal Status. Your Vehicle will remain in Auto Renewal Status until the odometer reaches 100,000 miles. Once Your Vehicle's odometer reaches 100,000 miles this Contract and all Coverage will expire and no longer be qualified for renewal or Auto Renewal Status.

DEFINITIONS CONT'D

Consequential Damage—Means an event or damage that occurs separately as a consequence or result of the failure of a covered or non-covered part, such as, loss of time or use, inconvenience, commercial loss, personal injury or property damage.

Registered—Means a claim has been Registered only when the Administrator has been contacted and has issued a claim reference number.

Pre-existing—Means a condition that within all reasonable mechanical probability relates to the mechanical fitness of Your Vehicle prior to Contract issuance.

Commercial Use—Means Vehicles Used for Farming or Ranching, Route Work, Job-Site Activities, Service or Repair Work, Delivery of Goods and Snow Removal (Vehicle must be equipped with factory installed or factory authorized snowplow package). Usage must not exceed manufacturer's ratings and/or limitations.

Preferred Repair Facility—A Repair Facility that has been selected and assigned by the Administrator to provide quality service to the customer (not available in all areas).

PROVISIONS OF THIS VEHICLE SERVICE CONTRACT

This CONTRACT is between US and YOU, and is subject to all the Terms and Conditions contained herein.

1. CONTRACT PERIOD

All Plans require a mandatory “Waiting Period” before Coverage takes effect. The “Waiting Period”=30 days and 1,000 miles from the Contract Origination Date and Odometer Mileage at Contract Origination Date.

2. COVERAGE

The Coverage afforded You for Your Vehicle is fully described in this Contract. Please see section: “Schedule of Coverages” of this Contract.

3. BREAKDOWN OF COVERED PARTS

We will pay or reimburse You for reasonable costs to repair or replace any Breakdown of a part listed in the Schedule of Coverages. REPLACEMENT PARTS MAY BE NEW, REMANUFACTURED, INDEPENDENTLY MANUFACTURED/DISTRIBUTED OR OF LIKE KIND AND QUALITY.

4. DEDUCTIBLE

In the event of a Breakdown covered by this Contract, You may be required to pay a Deductible. No Deductible payment is required with respect to Rental Coverage, if provided by this Contract. You have a Per Visit Deductible, as shown on the Registration Page that will be applied on a Per Repair Visit basis. Should a covered Breakdown take more than one visit to repair, only one Deductible will apply for that Breakdown. In addition, any Deductible will be waived for repairs made at a Preferred Repair Facility. You may contact the Administrator for help in locating a Preferred Repair Facility (not available in all areas).

5. TERRITORY

This Contract applies only to Breakdowns that occur and repairs made within the United States of America and Canada.

6. LIMITS OF LIABILITY

a. Per Repair Visit—Our liability for any one (1) Repair Visit shall in no event exceed the trade-in value of Your Vehicle at the time of said Repair Visit, as listed in the NADA Used Car Guide.

b. Aggregate—The total of all claims and benefits paid or payable while this Contract is in force shall not exceed the price You paid for Your Vehicle (excluding tax, title and license fees).

7. MAINTENANCE REQUIREMENTS

a. You must have Your Vehicle checked and serviced in accordance with the manufacturer's recommendations, as outlined in the Owner's Manual. NOTE: Your Owner's Manual lists different servicing recommendations based on Your individual driving habits and climate conditions. You are required to follow the maintenance Schedule that applies to Your conditions. Failure to follow the manufacturer's recommendations that apply to Your specific conditions may result in the denial of Coverage. If an Owner's Manual is not provided, You can contact the dealer or Administrator and the servicing recommendations will be provided to You.

b. It is required that verifiable receipts be retained for the service work. Or, if You perform Your own service, You must retain verifiable receipts showing purchases of all required parts and materials necessary to perform the required maintenance showing the date and mileage when the services were performed. Maintenance and/or service work receipts will be requested by the Administrator.

8. TRANSFER OF YOUR VEHICLE SERVICE CONTRACT

a. Your Contract is not transferable.

PROVISIONS OF THIS VEHICLE SERVICE CONTRACT CONT'D

9. OUR RIGHT TO RECOVER PAYMENT

If You have a right to recover against another party for anything We have paid under this Contract, Your rights shall become Our rights. You shall do whatever is necessary to enable Us to enforce these rights. We shall recover only the excess after You are fully compensated for Your loss.

10. FINANCIAL AGREEMENTS

If this Contract was financed (purchased on a payment plan) by a funding party, they shall be entitled to any refund(s) resulting from cancellation of this Contract for any reason including repossession of Your Vehicle, or total loss of Your Vehicle. Failure to make monthly payments in a timely manner may result in cancellation of this Contract and no refund will be due.

11. You are responsible for paying the Renewal Payment amount when due each month. If You set up Renewal Payments with credit card or ACH from a bank account, it is Your responsibility to make sure that the correct payment was remitted each month.

12. You must inform Us if Credit/Debit Card or other account used to make Renewal Payments changes or expires.

13. You must inform the Us when Your Vehicle reaches 100,000 miles on the odometer.

14. Your Renewal Payments will be waived if Your Vehicle has less than 100,000 Miles on the odometer and You have made the maximum number of Renewal Payments listed on the Registration Page. If Your Contract is placed in Auto Renewal Status and Your Vehicle has less than 100,000 miles on the odometer, this Contract will renew each month with waived Renewal Payments till Your Vehicle reaches 100,000 miles on the odometer, so long as You still own the Vehicle on the Registration Page of this Contract.
Services shall not be rendered under this contract unless the Origination Payment and the Renewal Payment, if due, have been received by Us. Renewal Payments must be received within 10 days of the Renewal Payment Due Date in order for this Contract to renew. Payment of each Renewal Payment serves to renew this Contract until the Renewal Payment Due Date of the next month, as listed on the Registration Page of this Contract. The Origination Payment keeps the contract in force for 60 days, 61 days from the Origination Date the Contract Renewal Payment will be due. If the Contract Renewal Payment Due Date falls on a non-business day, weekend or Holiday, the Renewal Payment Due Date will be extended for that Renewal Payment to the next business day. This Renewal Payment Due Date change will not affect the following Renewal Payment Due Date.
This Contract will be renewable until Your Vehicle reaches 100,000 miles on the Vehicle odometer. No claim will be authorized or paid if Your Vehicle has exceeded 100,000 miles on the Vehicle's Odometer. Renewal Payments on Your Contract must be current for a claim to be paid. Your claim will not be authorized or paid if Your Contract is in default for any reason. It is Your responsibility to make sure that Renewal Payments are paid when due. You are responsible for notifying Us should the expiration date or other account information of Your credit/debit card or other account used to make Renewal Payments on this Contract changes.

CANCELLATION OF YOUR CONTRACT

a. You may cancel this Contract by contacting the Administrator or the Seller from whom You purchased this Contract. An odometer statement indicating the odometer reading on the date of the request will be required.

b. We may cancel this Contract for non-payment of the Contract charge, or for misrepresentation in the submission of a claim. We may cancel this Contract if Your Vehicle is found to be modified in a manner not recommended by the manufacturer, or Your Vehicle is found to be used as a Commercial Vehicle and the applicable surcharge has not been marked on the Registration Page and payment has not been received for this surcharge.

c. If Your Vehicle and this Contract have been financed, the lienholder shown on the Registration Page may cancel this Contract for non-payment (except in the state of Utah), or if Your Vehicle is declared a total loss or is repossessed.

d. You may cancel this Contract within sixty (60) days of the Contract Origination Date, if no claim has been made, and receive a full refund of the Total Contract Origination Fee, less claims paid, where permitted. You may cancel this Contract at any other time and receive a pro rata refund of the Contract Renewal Payment based on the days since the last Renewal Payment Due Date compared to the Total Renewal Term, less the applicable cancellation fee of ($50) fifty dollars and claims paid, both where permitted. The Term of this Contract for cancellation purposes will be based on the Origination Date or the Renewal Date of this contract and the vehicle mileage on such date.

CONTRACT HOLDER'S GUIDE TO FILING A CLAIM

A. IF YOUR VEHICLE INCURS A BREAKDOWN, YOU MUST TAKE THE FOLLOWING STEPS TO FILE A CLAIM:

1. Prevent Further Damage—Take immediate action to prevent further damage. This Contract will not cover the damage caused by not securing a timely repair when a Breakdown has occurred. The operator is responsible for observing Vehicle warning lights and gauges, and taking appropriate action immediately. Failure to do so may result in the denial of Coverage.

CONTRACT HOLDER'S GUIDE TO FILING A CLAIM CONT'D

2. Take Your Vehicle to a Licensed Repair Facility—If Your Vehicle breaks down, take Your Vehicle to any licensed repair facility (You may contact the Administrator for help in locating a repair facility).

3. Provide Repair Facility with a copy of Your Contract and/or Your Contract Number.

4. Register repairs with the Administrator—Prior to any repair being made, instruct the Service Manager at the repair facility to contact the Administrator to Register the claim. Any claim for repairs that have not been Registered will not be covered except as provided under Emergency Repairs. The amount Registered with the Administrator is the maximum amount that will be paid for repairs covered under the terms of the Contract. Any additional amount must be Registered with the Administrator, prior to submitting the claim for payment.

5. Authorize Teardown and/or Inspection—In some cases, You may need to authorize the repair facility to inspect and/or teardown Your Vehicle in order to determine the cause and cost of the repair. You will be responsible for these charges if the failure is not covered under this Contract. We reserve the right to require an inspection of Your Vehicle prior to any repair being made.

6. Review Coverage—After the Administrator has been contacted, review with the Service Manager what will be covered by this Contract.

7. Pay any applicable Deductible—We will reimburse the repair facility or You for the cost of the work performed on Your Vehicle that is covered by this Contract and previously authorized, less the Deductible (if any). Once authorization is obtained, and the repair is completed, all repair orders and documentation must be submitted to the Administrator within sixty (60) days, (as soon as reasonably possible in Utah), to be eligible for payment.

8. Emergency Repairs—Should an emergency occur which requires a Breakdown repair be made at a time when the Administrator's office cannot be contacted, You must call the Administrator's office within five (5) business days from the date of repair, (as soon as reasonably possible in Utah), to determine if such repair will be covered by this Contract. If covered, You will be reimbursed for the repair.

B. IF YOUR VEHICLE BREAKS DOWN ON THE ROAD:

Follow the same steps as above. If necessary, the repair facility will be paid, less Your Deductible (if any), by the Administrator's national charge card system (MasterCard or VISA) on Your behalf. In some cases, You may need to pay the repair bill in full. If so, You will be reimbursed for the Registered amount of the repair, less Your Deductible (if any). If You have any questions regarding claim procedures or Coverages, please call the Administrator at the number below and ask for a Customer Support Representative:

Vemeco, Inc.

P.O. Box 410, Alvarado, Tex. 76009

Customer Service/Claims (888) 792-3495; Fax (817) 785-6702

Available 24 hrs/day-365 days/year

FOR YOUR ROAD CLUB SERVICES YOU MUST CALL 1-(866)-464-7396.

SERVICE MANAGER'S GUIDE TO FILING A CLAIM

STEPS TO FOLLOW WHEN FILING A CLAIM:

1. Advise Contract Holder—That evaluating the cause of the failure does not mean that the failure is covered under this Contract. All covered repairs must be Registered with the Administrator.

2. Contract Holder's Approval for Evaluation—Obtain approval from the Contract Holder to inspect and/or teardown Vehicle to determine cause and cost of repair. Save all components including fluids and filters, in the event the Administrator requires an inspection. Inform the Contract Holder that the cost of the teardown will not be paid if the failure of the component disassembled is not covered under the Contract.

3. Cause, Cure and Cost—Assess the problem(s), cause, cure of the failure and cost of the repairs.

NOTE: Any major component failure that has a verifiable complaint, i.e., slipping transmission, knocking engine, etc., should be called in prior to any teardown.

4. Register the Repair with the Administrator—Call the Administrator's Service Manager's Support representative at (888) 792-3495 to Register the claim. Please have the following items ready when You place the call:
a. Customer's Contract Number
b. Cause of Failure and Cure
c. Cost of the Repair

SERVICE MANAGER'S GUIDE TO FILING A CLAIM CONT'D

d. Factory Part Number(s)

5. The Support Representative will verify the Coverage and—

A. Register Claim—The Administrator will Register the claim by issuing a Reference Number. Record this Reference Number on the Repair Order. The Registered claim amount is the maximum that will be paid. Any additional amounts must be Registered with the Administrator, prior to submitting the claim for payment When You call in to Register the claim, We will adjust the labor hours according to a nationally recognized labor time guide, e.g., Factory, Motors, Mitchell, or All-Data.

OR

B. Request Additional Evaluation—Request further evaluation, teardown or outside inspection.

I. Inspection—The Administrator reserves the right to require an inspection of the Vehicle prior to any repair being accomplished. Diagnostic procedures not associated with the teardown are not covered.

II. Teardown—If a teardown is necessary in order to determine the cause of failure, the Contract Holder must approve the teardown. Please advise the Contract Holder that, if the component disassembled is not covered, then the Contract Holder must pay for the teardown.

Listed below is the Inspection Teardown Policy:

a. Save all components, including fluids and filters that need to be inspected. We may require covered components to be retained for Our disposal.

b. The Support Representative will arrange for inspection.

c. If not visited within 48 hours, call the Support Representative.

OR

C. Deny Claim—Deny the request and issue a Reference Number.

6. Review Repairs with Contract Holder—After the Administrator has been contacted, review with the Contract Holder what will be covered by the Contract and what portions of the repairs, if any, will not be covered.

7. Contract Holder's Approval for Repairs—Obtain the Contract Holder's approval to complete the repairs. All repair orders must have customer's signature.

8. Submit Repair Orders for Payment—All repair orders and documentation must be submitted to the Administrator, at the address noted under “Contract Holder's Guide to Filing A Claim” within sixty (60) days.

SCHEDULE OF COVERAGES

ULTIMATE COVERAGE (UKS)

We will pay or reimburse You for reasonable cost to repair or replace any Breakdown of all parts except for those items listed in the Exclusions Section of this Contract.

BENEFIT

RENTAL: In the event of a Breakdown covered by this Contract, We will pay or reimburse You for receipted expenses to rent a replacement Vehicle (from a licensed rental agency) or for alternate public transportation while Your Vehicle is at a licensed repair facility. Coverage will be provided to You on the following basis, up to a maximum of thirty-five dollars ($35) for every eight (8) labor hours, or portion thereof, of applicable labor time required to complete the repair, up to a maximum of one hundred seventy-five dollars ($175) for each repair visit. This Coverage does not apply to the time waiting for parts, services, weekends or other delays beyond the control of the repair facility or the Administrator. No Deductible will apply to this benefit.

SURCHARGED OPTIONAL COVERAGE

COMMERCIAL USE: If the Contract Registration Page shows that You purchased the Commercial Use option, see Commercial Use Definition for specific usage.

EXCLUSIONS

This Service Contract Provides No Coverage or Benefits:

A. For any part not specifically listed in the Schedule of Coverages, or for any of the following parts: carburetor, battery and battery cable/harness, standard transmission clutch assembly, friction clutch disc and pressure plate, distributor cap and rotor, safety restraint systems (including air bags), glass, lenses, sealed beams, light bulbs, fuses, circuit breakers, cellular phones, television/VCR/DVD players, game centers, AM/FM radio/cassette/CD players and speakers exceeding $300 repair or replacement costs, audio/video equipment, all touch screen and/or voice activated accessories including related display screens and heads up displays on windshields, electronic transmitting/receiving devices, global positioning systems, voice recognition systems, remote control consoles, radar detection devices, brake rotors and drums, all exhaust components, and the following emission components: EGR purge valve/solenoids/sensors, vacuum canister, vapor return canister, vapor return lines/valves, air pump/lines/valves, catalytic converter/filtering/sensors, emission vapor sensors, gas cap/filler neck, Weather strips, trim, moldings, bright metal chrome, upholstery and carpet, paint, outside ornamentation, bumpers, body sheet metal and panels, frame and structural body parts, vinyl and convertible tops, any convertible top assemblies, hardware or linkages, tires, wheel/rims. External nuts, bolts and fasteners are not covered unless specifically listed in the Schedule of Coverages (except where required in conjunction with a covered repair).

B. For maintenance services and parts described in Your Vehicle's owner's manual as supplied by the manufacturer and other normal maintenance services and parts which include, but are not limited to: alignments, adjustments, wheel balancing, tune-ups, spark plugs, spark plug wires, glow plugs, hoses (unless listed as specific covered parts), drive belts, brake pads, brake linings/shoes, and wiper blades. Filters, lubricants, coolants, fluids and refrigerants will be covered only if replacement is required in connection with a Breakdown.

C. For any damage and/or Breakdown resulting from collision, road hazard, fire, theft, vandalism, riot, explosion, lightning, earthquake, freezing, rust or corrosion, windstorm, hail, water or flood, acts of God, salt, environmental damage, chemicals, contamination of fluids, fuels, coolants or lubricants.

D. For any part that a repair facility or manufacturer recommends or requires that it be replaced or repaired, or is an update, and is not a Breakdown, is Your responsibility and expense. For any Breakdown caused by misuse, abuse, negligence, lack of normal maintenance required by the manufacturer's maintenance schedule for Your Vehicle or improper servicing or repairs subsequent to purchase. For any Breakdown caused by sludge build-up resulting from Your failure to perform recommended maintenance services, or failure to maintain proper levels of lubricants and/or coolants, or failure to protect Your Vehicle from further damage when a Breakdown has occurred or failure to have Your Vehicle towed to the service facility when continued operation may result in further damage.

Continued operation includes Your failure to observe warning lights, gauges, or any other signs of overheating or component failure, such as fluid leakage, slipping, knocking, or smoking, and not protecting Your Vehicle by continuing to drive creating damage beyond the initial failure.

E. For any repair or replacement of any covered part if a Breakdown has not occurred or if the wear on that part has not exceeded the field tolerances allowed by the manufacturer.

F. If any alterations have been made to Your Vehicle or You are using or have used Your Vehicle in a manner not recommended by the manufacturer, including but not limited to: the failure of any custom or add-on part, all frame or suspension modifications, lift kits, any tire that is not recommended by the original manufacturer if it creates an odometer/speedometer variance of greater than 4%, trailer hitches. Also not covered are any emissions and/or exhaust systems modifications, engine modifications, transmission modifications, and/or drive axle modifications, which includes any performance modifications.

G. If Your odometer has ceased to operate and odometer repairs have not been made immediately, or the odometer has been altered in any way subsequent to purchase, or if Your Vehicle has ever been a total loss, salvaged, rebuilt or is a grey market vehicle.

H. For any liability for property damage, or for injury to or death of any person arising out of the operation, maintenance or use of Your Vehicle described in this Contract, whether or not related to the parts covered. For loss of use, time, profit, inconvenience, or any other consequential loss (except as may otherwise be provided under the Schedule of Coverages), including any Consequential Damage to a non-covered part that results from a Breakdown.

I. When the responsibility for the repair is covered by an insurance policy, manufacturer and/or dealer customer assistance program, or any warranty from the manufacturer, such as extended drivetrain, major component or full coverage warranties (regardless of the remaining manufacturer's warranty when You purchased this Contract), or a repairer's guarantee/warranty. Further, Coverage under this Contract is similarly limited in the event of a Breakdown if the manufacturer has announced its responsibility through any means, including public recalls and factory service bulletins.

J. If Your Vehicle is used for towing (unless Your Vehicle is equipped with factory installed or factory authorized tow package), or is used as a Commercial unit (unless appropriate surcharge is marked on the Registration Page and only as defined under “Definitions”, “Commercial Use”), or is used for rental, taxi, limousine or shuttle, towing/wrecker service, dumping (dump beds), cherry pickers, lifting or hoisting, police or emergency service, principally off-road use, prearranged or organized racing or competitive driving.

K. For any Pre-existing condition or for any Breakdown occurring before Coverage takes effect or prior to the Contract purchase date, or if the information provided by You, or the repair facility cannot be verified as accurate or is found to be deceptively inaccurate.

L. For Breakdowns that occur and/or repairs made outside of the United States of America and Canada.

M. For diagnostic and/or teardown procedures that are not listed, or are in excess of the times listed in the current year's national flat rate hourly guide in conjunction with a covered repair.

In the above example of an embodiment of a contract, certain sections are particularly instrumental in producing a renewable contract. These sections include, in the definitions section, the lines starting with “Contract Origination Date”, to the line “DEFINITIONS CONT'D”; section 8.a., and 11 through 14 under “PROVISIONS OF THIS VEHICLE SERVICE CONTRACT”; and section d., under “CANCELLATION OF YOUR CONTRACT”.

Some information, functions, and the like may be described herein as being required, but may only be required in certain embodiments, for example, to provide structure or guidance to the process of using the invention by a particular user. Further, benefits, other advantages, and solutions to problems have been described herein with regard to specific embodiments. However, the benefits, advantages, solutions to problems, and element(s) that may cause benefit, advantage, or solution to occur or become more pronounced are not to be construed as critical, required, or essential features or elements of the claims or the invention. Reference to an element in the singular is not intended to mean “one and only one” unless explicitly so stated, but rather “one or more.” As used herein, the terms “comprises”, “comprising”, or a variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

What is claimed is:

1. A method of transferring risk of repair costs for repairs to an apparatus, the method comprising at least:
providing a written document to be signed by an owner of the apparatus to form a contract wherein the contract provides for funding for repairs to the apparatus for a first period of time in exchange for a first payment and the contract provides the owner a right to renew the contract for at least a plurality of second periods of time subsequent to the first period of time upon submission of a second payment delineated in the contract for each second period of time.

2. The method of claim 1 wherein the first period of time and the second period of time, are each no less than one week and no more than one quarter of one year.

3. The method of claim 1 wherein the second periods of time are each one month.

4. The method of claim 1 wherein the funding for repairs is provided in accordance with a set of terms and the terms are substantially the same for the first period and at least one second period.

5. The method of claim 4 wherein the apparatus is a vehicle having an odometer and the terms change when the odometer reaches a distance reading delineated in the contract.

6. The method of claim 1 wherein the apparatus is a vehicle having an odometer and the contract terminates when the odometer reaches a distance reading delineated in the contract.

7. The method of claim 6 wherein the contract delineates a particular number of second payments after which the contract reaches an auto-renewal status during which the funding for repairs continues without further second payments until the odometer reaches the distance reading delineated in the contract.

8. The method of claim 1 further comprising entering into the contract with the owner to provide the funding for repairs.

9. The method of claim 1 further comprising in any order:
offering to a purchaser of the apparatus, at the time of a purchase of the apparatus, the transferring of risk of repair costs for repairs to the apparatus;
discussing the funding for repairs to the apparatus with the purchaser; and
providing the written document to the purchaser.

10. The method of claim 1 further comprising in any order:
advertising to potential customers regarding the transferring risk of repair costs for repairs to the apparatus;
receiving telephone calls from at least a portion of the potential customers in response to the advertising;
discussing the funding for repairs to the apparatus with the portion of the potential customers on the telephone; and
sending the written document to the portion of the potential customers wherein at least a fraction of the potential customers are the owners.

11. The method of claim 10 wherein the advertising to potential customers includes targeting at least one of purchasers of vehicles and purchasers of service contracts.

12. The method of claim 11 wherein:
the first period of time is no less than one week and no more than one half of one year;
at least a plurality of the second periods of time are each one month;
the apparatus is a vehicle having an odometer and the contract terminates when the odometer reaches a distance reading delineated in the contract;
the contract delineates a particular number of second payments after which the contract reaches an auto-renewal status and the coverage continues without additional second payments until the odometer reaches the distance reading delineated in the contract.

13. A method of providing funding of repair services for an apparatus, the method comprising at least:
providing a written document to be signed by an owner of the apparatus to form a contract wherein the contract provides funding for repair services for the apparatus for at least a period of time in exchange for at least a plurality of payments, and wherein the contract provides for any unearned portion of the payments to be converted to extended funding for repair services for the apparatus when and if the owner stops making payments before completion of an anticipated payment schedule.

14. The method of claim 13 wherein the apparatus is a vehicle having an odometer and the contract delineates a particular number of payments after which the funding for repair services continues without further payment until the odometer reaches a distance reading delineated in the contract.

15. The method of claim 13 further comprising in any order:
advertising to potential customers regarding funding of repair services;
receiving telephone calls from a portion of the potential customers in response to the advertising;
discussing the funding of repair services with the portion of the potential customers on the telephone;
sending the written document to the portion of the potential customers wherein at least a fraction of the potential customers are the owners; and
entering into the contract with at least a plurality of the owners to provide the funding of repair services.

16. The method of claim 15 wherein advertising to potential customers includes sending direct mail to at least one of purchasers of vehicles and purchasers of service contracts.

17. An article for transferring risk of repair costs for repairs to a motor vehicle, the article comprising a written document to be signed by an owner of the motor vehicle to form a contract to provide funding for repair services for the motor vehicle for a first period of time in exchange for a first payment and wherein the contract provides the owner a right to renew the contract for funding for repair services for a second period of time immediately subsequent to the first period of time upon submission of a second payment delineated in the contract, and wherein the contract provides the owner a right to repeatedly renew the contract for funding for repair services for a plurality of subsequent periods of time subsequent to the second period of time upon submission of subsequent payments delineated in the contract for each subsequent period of time.

18. The article of claim 17 wherein at least a plurality of the subsequent periods of time are each one month.

19. The article of claim 17 wherein the motor vehicle has an odometer and the contract terminates when the odometer reaches a distance reading delineated in the contract.

20. The article of claim 19 wherein the contract delineates a particular number of payments after which the contract reaches an auto-renewal status during which the funding for repair services continues without further subsequent payment until the odometer reaches the distance reading delineated in the contract.
